(19) United States
(12) Patent Application Publication
(10) Pub. No.: US 2010/0323208 A1
(43) Pub. Date: Dec. 23, 2010

(54) Plastic-thin metal film and method for preparing the same

(76) Inventors: Seung-ho Song, Choongcheongbuk-do (KR); Yoo-duck Won, Kyunggi-do (KR); Hak-min Lee, Kyunggi-do (KR)

Correspondence Address: CLARK & BRODY, 1700 Diagonal Road, Suite 510, Alexandria, VA, 22314, US

(21) Appl. No.: 12/312,247

(22) PCT Filed: Nov. 2, 2007
(86) PCT No.: PCT/KR2007/005521

§ 371 Date: May 1, 2009

(30) Foreign Application Priority Data
Nov. 3, 2006 (KR) 10-2006-0108545

(51) Int. Cl. B32B 15/08; B32B 15/09; B32B 15/088; B32B 15/085; B32B 15/082; B32B 37/14

(52) U.S. Cl. 428/447; 156/272.6

(57) ABSTRACT

The present invention relates to a plastic-thin metal film and a method for preparing the same, and more precisely a plastic-thin metal film and a method for preparing the same which can improve an adhesion strength between the plastic substrate and the thin metal film, by forming a reactive functional group on a surface of a plastic substrate by plasma treatment and bonding the plastic substrate to a thin metal film by coating the plastic substrate or the thin metal film with an adhesive composition containing a reactive material which can be chemically bound to the reactive functional group.

### TECHNICAL FIELD

The present invention relates to a plastic-thin metal film and a method for preparing the same, and more particularly to a plastic-thin metal film with improved bond strength between a plastic substrate and a thin metal film resulted from the processes of forming a reactive functional group on a surface of the plastic substrate by plasma treatment and bonding the thin metal film to the plastic substrate using an adhesive composition containing a silane-based reactive material which can be chemically bound to the reactive functional group, and a method for preparing the same.

### BACKGROUND ART

As electronic machines have recently become thin and light, many parts of prior Printed Circuit Board (PCB) are replaced by Flexible Copper Clad Laminates (hereinafter, FCCL).

Plastic materials used for such FCCL need properties such as stable heat-resistant even at a soldering temperature after performing a Surface Mounting Technology (SMT) and low dielectric constant for the purpose of lowering impedance. To satisfy such properties, the plastic materials such as polyimide, Teflon, and silicone are representatively used.

However, such plastic materials having strong hydrophobic surface properties show problems that it is difficult to being bonded to any materials by the adhesive for its intrinsic release properties and thus being peeled that it is also difficult for thin metal film to being easily bonded to the plastic materials.

In order to solve such problem and thus produce the FCCL having superior quality, the prior art uses a method of depositing the thin metal film by Chemical Vapor Deposition (hereinafter, CVD) after etching the surface of the plastic substrate by a chemical method or an electronic method such as Corona and Atmospheric Plasma, or a method of coating a surface of the etched plastic substrate with the curable material and laminating the thin metal film to cure the coated curable material.

However, there are still problems in that the deposited thin metal film is elongated in a direction of a applied force due to the ductility of the metal since the thin metal film is deposited on the plastic substrate with expanded surface area as a result of etching in the case of preparing the plastic-thin metal film via the CVD, and the plastic substrate and the thin metal film can be easily peeled due to repetitive relaxation-contraction such as temperature shock since they are bonded only by physical adhesion strength in the case of coating the curable material and laminating the thin metal film to cure the curable material.

### DISCLOSURE

### Technical Problem

An object of the present invention is to provide a plastic-thin metal film which shows excellent adhesion strength between a plastic substrate and a thin metal film.

Another object of the present invention is to provide a method of preparing the plastic-thin metal film.

### Technical Solution

The present invention provides a plastic-thin metal film characterized in that a plastic substrate having a reactive functional group formed on a surface thereof is bonded to a thin metal film using an adhesive composition containing a silane-based reactive material which can be chemically bound to the reactive functional group of the plastic substrate.

Further, the present invention provides a method for preparing a plastic-thin metal film, comprising the following steps:

i) forming a reactive functional group on a surface of a plastic substrate by plasma treatment; and

ii) bonding the plastic substrate to a thin metal film by coating the plastic substrate or the thin metal film with an adhesive composition containing a reactive material capable of being chemically bound to the reactive functional group.

Hereinafter, it will be explained on each step according to the method for preparing the film.

i) Forming a Reactive Functional Group on a Surface of a Plastic Substrate by Plasma Treatment;

In this step, the plasma treatment is performed on the surface of the plastic substrate in order to improve the adhesion strength between the plastic substrate and the thin metal film. By the plasma treatment, the reactive functional group is formed on the surface of the plastic substrate, which is probably containing oxygen in the reactive functional group such as —OH, —OOH, —COOH, —C—O—, —C═O, —O—C—O—, etc.

However, it is not necessarily limited to them, but any reaction groups capable of being chemically bound to silane-based reactive material mentioned below can be used.

The plasma treatment is performed under the general condition, but is preferably carried out under the pressure of up to 1×10⁻³ torr for the effective generation of the reactive functional group on the surface of the plastic substrate. If the plasma treatment is performed under the higher pressure, arc discharge resulted by impurities will be a problem or generation density of the reactive functional group might be decreased because of scattering.

The amounts of oxygen and argon injected into an ion gun for the plasma treatment are not particularly limited, but the weight ratio of oxygen to argon is preferably 1:1-4:1.

As the induced voltage increases during the plasma formation, discharging density of the plasma increases, resulting in the increase of the generation of the reactive functional group on the surface of the plastic substrate. Therefore, the induced voltage is preferably 10-4000 W, more preferably, 100-3000 W.

It is generally expected that surface etching will be observed after the plasma treatment. However, as shown in FIG. 1-FIG. 3, contact angles of PET before the plasma treatment (FIG. 1), right after the plasma treatment (FIGS. 2) and 24 hours after the plasma treatment (FIG. 3), were respectively 109.46°, 24.25° and 40.37°. These results indicate that the reactive functional groups are formed on the surface of the plastic substrate by the plasma treatment but as time went by those reactive functional groups are reduced by the reaction with substances in the air.

Therefore, it was confirmed that the plastic according to the present invention can have reactive functional groups on its surface after plasma treatment.

As the plastic substrate, it is not particularly limited, but a film with a polar group on its surface, as well as an olefin-based film with a non-polar group can be used. In particular, films used for electronic material such as polyethylene film, polypropylene film, polystyrene film, polyester film, polyamide film, polyimide film, polycarbonate film, tetraacetylcellulose, Teflon film, and silicone film are preferred.

ii) Bonding the Plastic Substrate to a Thin Metal Film by Coating the Plastic Substrate or the Thin Metal Film with an Adhesive Composition Containing a Reactive Material Capable of being Chemically Bound to the Reactive Functional Group.

In this step, the surface of the plastic substrate is coated with the adhesive composition containing silane-based reactive material that can be chemically bound to the reactive functional group formed on the surface of the plastic substrate or the thin metal film, followed by bonding.

The adhesive is not particularly limited, but can be used with liquid-phase silicone-based adhesive containing acrylic group or vinyl group.

Further, the silane-based reactive material is represented by the following formula 1.

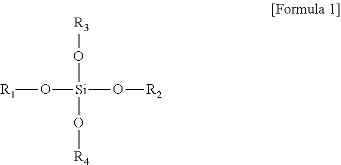

(Wherein, Ri is hydrogen or vinyl group, and R₂-R₄ are Ci-Ci₈ alkyl group or C₃-Ci₈ alkyl group having epoxy group at terminal.)

Since the silane-based reactive material is chemically bound to the reactive functional group of the plastic substrate formed by the plasma treatment, and is chemically bound to the thin metal film and the adhesive, the adhesion strength between the plastic substrate and the thin metal film can be improved comparing to the case of using only adhesive.

The silane-based reactive material has a content of 0.1-30 weight % with respect to total weight of the adhesive composition, and preferably 0.5-15 weight %.

If the reactive material has a content of less than 0.1 weight %, the adhesion strength can be weakened, and if the reactive material has a content of more than 30 weight %, air bubbles will be formed because of by-products, which results in poor adhesion strength as well.

The adhesive composition can further contain a tin-based catalyst to induce satisfactory reaction of the silane-based reactive material with the reactive functional group formed on the surface of the plastic substrate, and the tin-based catalyst is represented by the following formula 2.

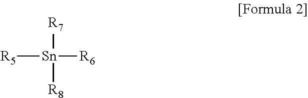

(Wherein, R₅-R₈ are Ci-Ci₈ Alkyl Group.)

The tin-based catalyst has a content of 0.01 to 5 weight % with respect to total weight of the adhesive composition containing the catalyst, and preferably 0.1 to 2 weight %.

Further, the adhesive composition can additionally contain curing agents, inorganic fillers, and physical property modifiers, if necessary.

Further, the thin metal film is not particularly limited, but can be selected at least one from a group consisting of copper, aluminum, nickel and chromium.

Further, any one surface of the thin metal film can be oxidized using sulfuric acid in order to improve the adhesion strength with the product to be bonded, but is not necessarily limited to it.

After any one of the thin metal film or the plastic substrate is coated with the adhesive composition, they are laminated and then cured at a temperature of 80 to 150° C.

A coating thickness of the adhesive composition can range from about 1 to 100 μm.

### DESCRIPTION OF DRAWINGS

The above and other objects, features and advantages of the present invention will become apparent from the following description of preferred embodiments given in conjunction with the accompanying drawings, in which:

FIG. 1 is a photograph showing the contact angle of the surface of the plastic substrate before the plasma treatment.

FIG. 2 is a photograph showing the contact angle of the surface of the plastic substrate right after the plasma treatment according to the present invention.

FIG. 3 is a photograph showing the contact angle of the surface of the plastic substrate when 24 hours have elapsed after the plasma treatment according to the present invention.

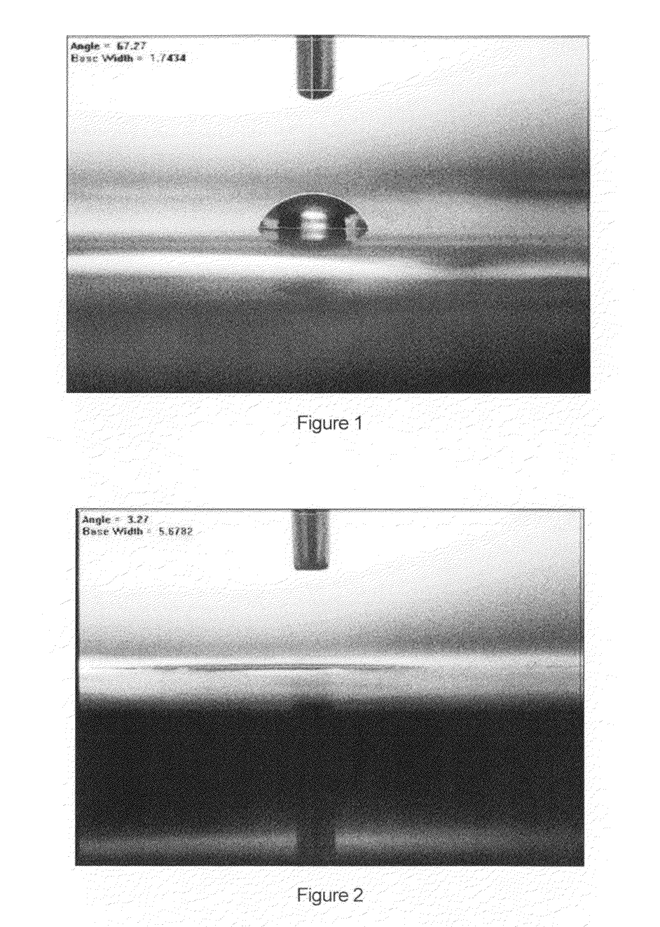

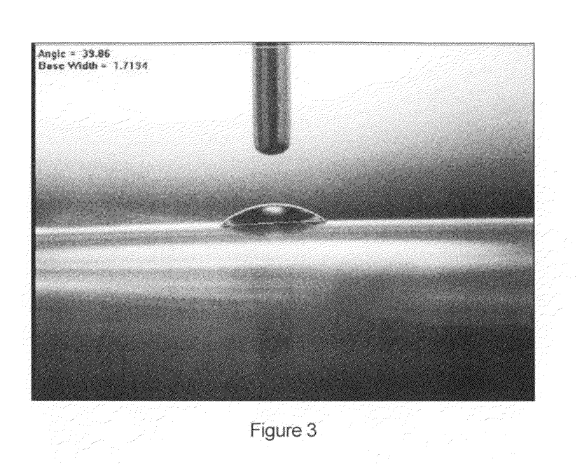

### BEST MODE

Hereinafter, the embodiments of the present invention will be described in detail with reference to accompanying drawings.

### EXAMPLES

### Example 1

The reactive functional group was formed on a surface of a Teflon film by using a plasma processing apparatus in which a weight ratio of oxygen to argon is 4:1 and induced voltage is 1,OOOV/0.2-1 .OA (200-1 000 W).

Next, the surface of the Teflon film treated by plasma was coated with the adhesive composition comprising 99.4 weight part of acrylic-based adhesive, 0.5 weight part of silane-based reactive material in which Ri to R₃ is a methyl group and R4 is a acrylic group in the formula 1, and 0.1 weight part of tin-based catalyst in which R5 to Re is a butyl group and R₇ to R₈ is a lauryl group in the formula 2 with a thickness of 5 μa, followed by laminating a thin copper film having a thickness of 12 m over the Teflon film, and curing them at 100° C. for 5 minutes, whereby a plastic-thin metal film is prepared.

### Example 2

The plastic-thin metal film is prepared by the same manner as described in the Example 1 except for using the adhesive composition comprising 69.9 weight part of acrylic-based adhesive, 30 weight part of silane-based reactive material, and 0.1 weight part of tin-based catalyst.

### Example 3

The plastic-thin metal film is prepared by the same manner as described in the Example 1 except for using the adhesive composition comprising 84.9 weight part of acrylic-based adhesive, 15 weight part of silane-based reactive material, and 0.1 weight part of tin-based catalyst.

### Example 4

The plastic-thin metal film is prepared by the same manner as described in the Example 1 except for using the adhesive composition comprising 83 weight part of acrylic-based adhesive, 15 weight part of silane-based reactive material, and 2 weight part of tin-based catalyst and oxidizing one surface of the thin copper film having a thickness of 12 μm.

### Example 5

The plastic-thin metal film is prepared by the same manner as described in the Example 1 except for using the adhesive composition comprising 75 weight part of liquid-phase silicone containing vinyl group instead of acrylic-based adhesive, 0.5 weight part of silane-based reactive material, and 0.1 weight part of tin-based catalyst and, in addition, using 3 weight part of curing agent (poly(methylhydro siloxane-co-dimethyl siloxane)), 20 weight part of alumina as an inorganic filler, 0.5 weight part of platinum-based curing catalyst, and 0.9 weight part of silica nano-particle as a physical property modifier.

### Comparative Example

### Comparative Example 1

The plastic-thin metal film is prepared by coating the surface of the Teflon film non-treated with plasma with the adhesive composition comprising 99.4 weight part of acrylic-based adhesive, 0.5 weight part of silane-based reactive material, and 0.1 weight part of tin-based catalyst with a thickness of 50 j<<m, followed by laminating the thin copper film of 12//m, and curing them at 100° C. for 5 minutes.

### Comparative Example 2

The plastic-thin metal film is prepared using the same manner as described in the Example 1 except for using 100 weight part of acrylic-based adhesive which does not contain the silane-based reactive material and the tin-based catalyst.

### Experiment Example

It is tested whether the plastic-thin metal film prepared in accordance with the embodiments 1 to 5 and the comparative examples 1 and 2 is peeled or not i) right after preparation, ii) 24 hours after preparation, iii) 100 hours, 500 hours, and 1,000 hours after preparation at a temperature of 120° C. and their results are shown in the table 1 indicated below.

TABLE 1

| | | | After anti-environment | | |
|---|---|---|---|---|---|
| | Right | 24 hrs | test (120° C.) | | |
| | after | after | 100 | 500 | 1,000 |
| | preparation | preparation | hrs | hrs | hrs |
| Example 1 | No | No | No | No | No |
| | peeling | peeling | peeling | peeling | peeling |
| Example 2 | No | No | No | Bubbles | Peeling |
| | peeling | peeling | peeling | generated | |
| Example 3 | No | No | No | No | No |
| | peeling | peeling | peeling | peeling | peeling |
| Example 4 | No | No | No | No | No |
| | peeling | peeling | peeling | peeling | peeling |
| Example 5 | No | No | No | | No |
| | peeling | peeling | peeling | | peeling |
| Compar- | No | Peeling | | | |
| ative | peeling | | | | |
| example 1 | | | | | |
| Compar- | No | Peeling | | | |
| ative | peeling | | | | |
| example 2 | | | | | |

### INDUSTRIAL APPLICABILITY

According to the plastic-thin metal film prepared of the present invention, the reactive functional group is formed on the surface of the plastic substrate by the plasma treatment and the adhesive composition contains certain contents of the silane-based reactive material in order that the silane-based reactive material is chemically bound to the reactive functional group of the plastic substrate, whereby it is possible to significantly improve the bond strength between the plastic substrate and the thin metal film.

1. A plastic-thin metal film characterized in that a plastic substrate having a reactive functional group formed on a surface thereof is bonded to a thin metal film using an adhesive composition containing a silane-based reactive material which can be chemically bound to the reactive functional group of the plastic substrate.

2. The plastic-thin metal film according to claim 1, wherein the plastic substrate is selected at least one from a group consisting of polyethylene, polypropylene, polystyrene, polyester, polyamide, polyimide, polycarbonate, tetraacetylcellulose, Teflon, and silicone.

3. The plastic-thin metal film according to claim 1, wherein the silane-based material has a structure represented by a formula 1 as follows: 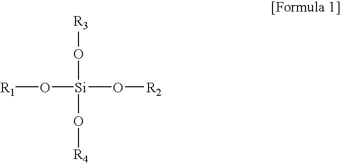
(Wherein, Ri is hydrogen or vinyl group, and R₂-R₄ are Ci-Ci₈ alkyl group or C₃-Ci₈ alkyl group having epoxy group at terminal.)

4. The plastic-thin metal film according to claim 1, wherein the silane-based reactive material has a content of 0.1 to 30 weight % with respect to total weight of the adhesive composition.

5. The plastic-thin metal film according to claim 1, wherein the adhesive composition further contains tin-based catalyst having a structure represented by a formula 2 as following: 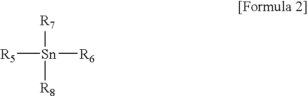
(Wherein, R₅-R₈ are Ci-Ci₈ alkyl group.)

6. The plastic-thin metal film according to claim 5, wherein the tin-based catalyst has a content of 0.01 to 5 weight % with respect to total weight of the adhesive composition containing the catalyst.

7. The plastic-thin metal film according to claim 1, wherein the thin metal film is selected at least one from group consisting of copper, aluminum, nickel and chromium.

8. A method for preparing a plastic-thin metal film, comprising steps of:
i) forming a reactive functional group on a surface of a plastic substrate by plasma treatment; and
ii) bonding the plastic substrate to a thin metal film by coating the plastic substrate or the thin metal film with an adhesive composition containing a reactive material which can be chemically bound to the reactive functional group.

9. The method for preparing a plastic-thin metal film according to claim 8, wherein the plasma treatment is performed under a low pressure below 1×10 torr.
